(19) United States
(12) Patent Application Publication
(10) Pub. No.: US 2016/0352056 A1
(43) Pub. Date: Dec. 1, 2016

(54) FAST CHARGING DUAL MODE CHARGING CONNECTOR

(71) Applicant: MAPTECH. CO., LTD., Gyeonggi-do (KR)

(72) Inventors: Ho Seong KO, Seoul (KR); Sang Min HYUN, Gwangmyeong-city (KR)

(73) Assignee: MAPTECH CO., LTD., Anyang-City (KR)

(21) Appl. No.: 14/431,410

(22) PCT Filed: Feb. 25, 2014
(86) PCT No.: PCT/KR2014/001534

§ 371 Date: Mar. 26, 2015

(30) Foreign Application Priority Data
Feb. 5, 2014 (KR) 10-2014-0013179

(51) Int. Cl. H01R 27/00; H01H 1/36; H01R 24/62

(52) U.S. Cl. CPC H01R 27/00; H01R 24/62; H01H 1/365; H01R 2107/00

(57) ABSTRACT

A fast charging dual mode charging connector that allows any one of opposite surfaces thereof to be connected to a USB port to perform data communication at the same time when a portable terminal is charged, or to fast charge the portable terminal without performing data communication includes: a plug having a first data terminal for data communication and a first charging terminal for charging on any one of opposite surfaces thereof and having a second data terminal and a second charging terminal on an opposite surface thereof, and having one end inserted into a connection port; a body on which the plug is mounted such that one end of the plug protrudes; and a switch for, if the plug is inserted into the connection port such that the second charging terminal is connected to the connection port, short-circuiting the second data terminal.

### TECHNICAL FIELD

The present invention relates to a fast charging dual mode charging connector, and more particularly to a USB connector that allows any one of opposite surfaces thereof to be connected to a USB port to perform data communication at the same time when a portable terminal is charged, or to fast charge the portable terminal without performing data communication.

### BACKGROUND ART

Methods for charging a conventional portable terminal such as a smartphone, a mobile phone, an MP3 player, or a camera include a charging a portable terminal through a general AC charger directly connected to a power receptacle and a method of charging a portable terminal through a USB cable unit connected to a USB port installed in a computer.

However, in a method of charging a portable terminal through a USB cable unit, the portable terminal is charged at a speed lower than in a method of charging a portable terminal through a general AC charger.

A smartphone of a portable terminal manufacturer charges the smartphone with a maximum current of 1 A when the smartphone is charged with a general charger, but charges the smartphone slowly as the current is limited to a maximum of 0.5 A when the smartphone is charged using a USB cable and a USB port.

As described above, this is because data communication and charging are performed at the same time when the portable terminal is connected to a computer using a USB cable and a USB port and only a current of 0.5 A is supplied to the portable terminal in a USB standard specification (2.0 Standard) to stably perform data communication.

However, as new portable terminals have been developed and released, the recent portable terminals have been designed to use a charging current corresponding to 1.0 A or more and up to 1.8 A to 2.4 A.

Accordingly, it is necessary to fast charge the portable terminals according to a necessity of the user while securing stable data communication between a computer and the portable terminal connected to each other by a USB cable.

### DISCLOSURE

### Technical Problem

The present invention has been made in an effort to solve the above-mentioned problems, and provides a fast charging dual mode charging connector that allows any one of opposite surfaces thereof to be connected to a USB port to perform data communication at the same time when a portable terminal is charged, or to fast charge the portable terminal without performing data communication.

### Technical Solution

In accordance with an aspect of the present invention, there is provided a fast charging dual mode charging connector including: a plug having a first data terminal for data communication and a first charging terminal for charging on any one of opposite surfaces thereof and having a second data terminal and a second charging terminal on an opposite surface thereof, and having one end inserted into a connection port; a body on which the plug is mounted such that one end of the plug protrudes; and a switch for, if the plug is inserted into the connection port such that the second charging terminal is connected to the connection port, short-circuiting the second data terminal.

The body has a movement groove, and the switch includes: a slider moved along the movement groove; a short circuit part mounted on the slider to short-circuit the second data terminal while contacting the second data terminal if the slider is moved towards an opposite end of the plug; and a resilient body resiliently supporting the slider towards the one end of the plug.

A first stopper step and a second stopper step are formed in the body to be spaced apart from each other in the lengthwise direction of the plug, a stopper disposed between the first stopper step and the second stopper step protrudes from the slider, and movement of the slider is restricted while the stopper contacts the first stopper step or the second stopper step.

The fast charging dual mode charging connector may further includes a guide pin mounted on the body, for guiding movement of the switch.

The switch includes: a slider having a guide hole into which the guide pin is inserted such that the guide pin is moved along the guide hole; a short circuit part mounted on the slider to short-circuit the second data terminal while contacting the second data terminal if the slider is moved towards an opposite end of the plug; and a resilient body into which the guide pin is inserted and resiliently supporting the slider towards the one end of the plug.

The first charging terminal and the second charging terminal include a VBUS terminal and a GND terminal, respectively, the first data terminal and the second data terminal include a D+ terminal and a D− terminal, respectively, and the short-circuit part electrically connects the D+ terminal and the D− terminal of the second data terminal.

The plug has a mounting part mounted on the body and an insertion part inserted into the connection port, the first charging terminal, the first data terminal, and the second charging terminal are inserted into the mounting part and the insertion part, and the second data terminal is formed in the mounting part.

### Advantageous Effects

The fast charging dual mode charging connector according to the present invention has the following effect.

Because charging terminals are formed on opposite surfaces of the fast charging dual mode charging connector such that only charging is performed without performing data communication through a charging terminal formed on any one of the opposite surfaces, the fast charging dual mode charging connector allows any one of opposite surfaces thereof to be connected to a USB port to perform data communication at the same time when a portable terminal is charged, or to fast charge the portable terminal without performing data communication.

### DESCRIPTION OF DRAWINGS

FIG. 1 is views illustrating a fast charging dual mode charging connector according to a first embodiment of the present invention;

FIG. 2 is a perspective view illustrating the fast charging dual mode charging connector according to the first embodiment of the present invention when the fast charging dual mode charging connector is viewed from one side;

FIG. 3 is perspective views illustrating the fast charging dual mode charging connector according to the first embodiment of the present invention when the fast charging dual mode charging connector is viewed from another side;

FIG. 4 is exploded perspective views illustrating the fast charging dual mode charging connector according to the first embodiment of the present invention;

FIG. 5 is sectional views illustrating the fast charging dual mode charging connector according to the first embodiment of the present invention;

FIG. 6 is a perspective view illustrating the fast charging dual mode charging connector according to a second embodiment of the present invention when the fast charging dual mode charging connector is viewed from one side;

FIG. 7 is perspective views illustrating the fast charging dual mode charging connector according to the second embodiment of the present invention when the fast charging dual mode charging connector is viewed from another side;

FIG. 8 is exploded perspective views illustrating the fast charging dual mode charging connector according to the second embodiment of the present invention; and

FIG. 9 is sectional views illustrating the fast charging dual mode charging connector according to the first embodiment of the present invention.

### BEST MODE

### Mode for Invention

A connector according to the present invention may function as a part of a USB cable or a USB memory or a part of a portable device directly connected to a USB connection port.

The connection port is mounted to a computer or the like, and data may be communicated between a computer and a portable terminal or the portable terminal may be charged through the USB connection port.

Hereinafter, although a connector of the present invention will be described as an element of a USB cable in exemplary embodiments of the present invention, a target of the present invention is not limited to a USB cable.

### First Embodiment

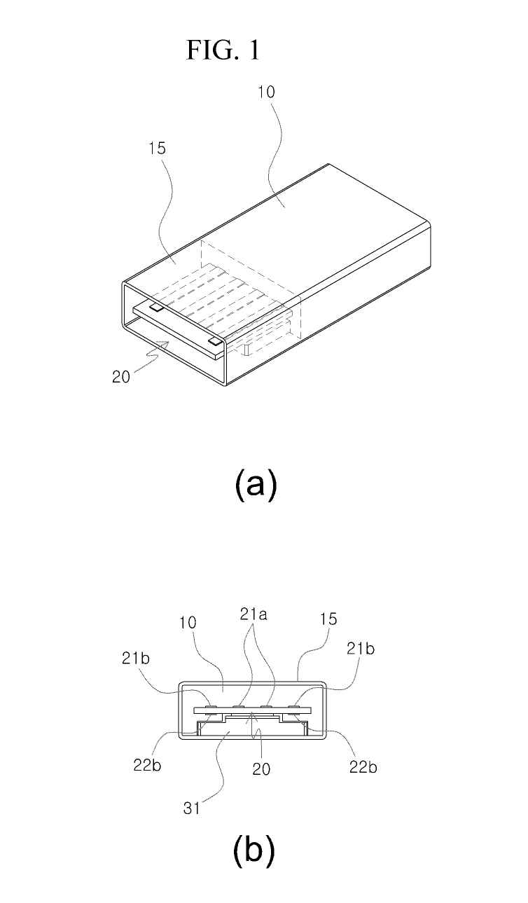

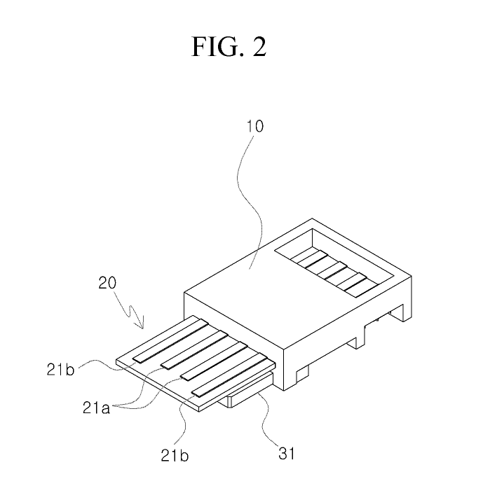

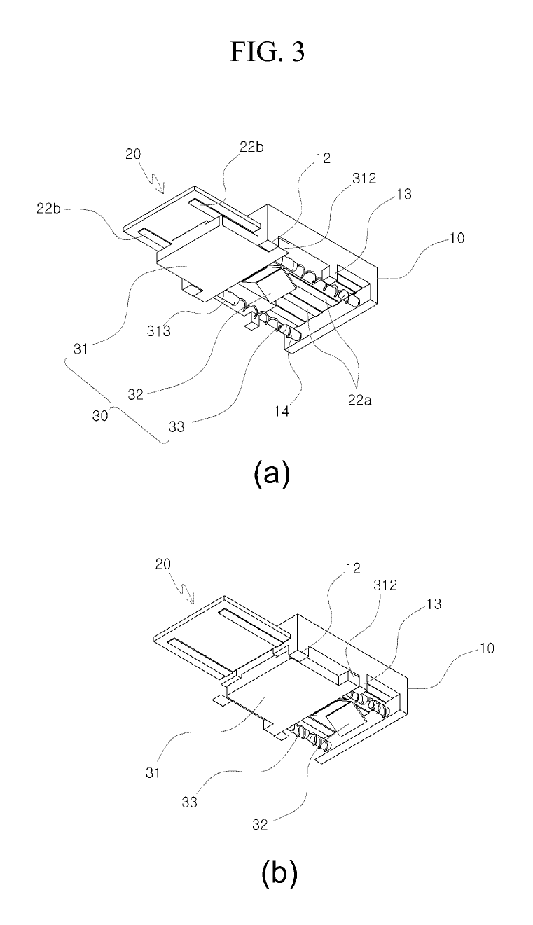

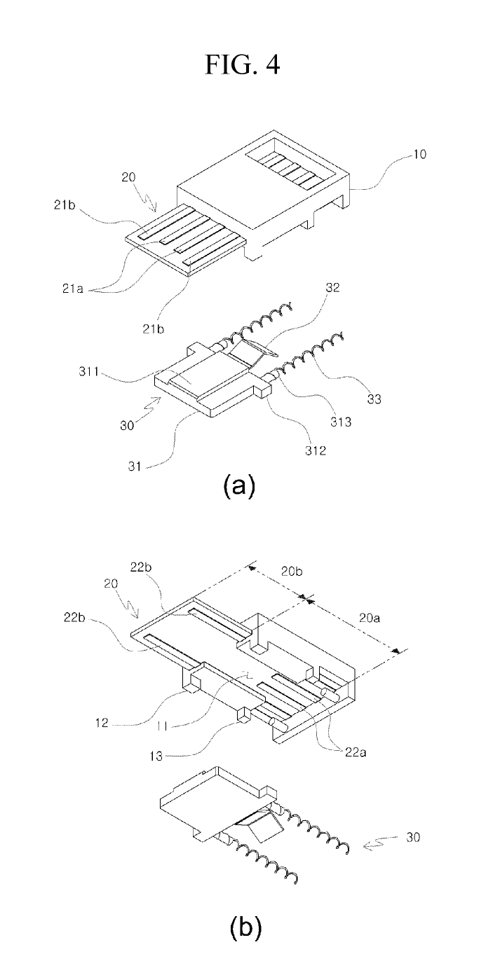

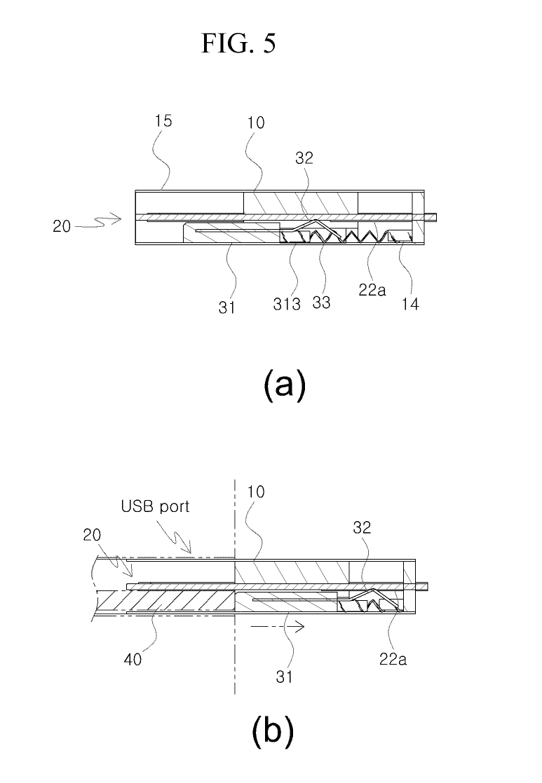

FIG. 1A is a perspective view illustrating a fast charging dual mode charging connector according to a first embodiment of the present invention. FIG. 1B is a view illustrating the fast charging dual mode charging connector according to the first embodiment of the present invention when the fast charging dual mode charging connector is viewed from the front side. FIG. 2 is a perspective view of the fast charging dual mode charging connector except for a case when the fast charging dual mode charging connector is viewed from one side. FIG. 3A is a perspective view illustrating the fast charging dual mode charging connector according to the first embodiment of the present invention when the fast charging dual mode charging connector is viewed from another side. FIG. 3B is a view illustrating a state in which a slider is moved rearwards from the state of FIG. 3A. FIG. 4A is an exploded perspective view illustrating the fast charging dual mode charging connector according to the first embodiment of the present invention when the fast charging dual mode charging connector is viewed from one side. FIG. 4B is an exploded perspective view illustrating the fast charging dual mode charging connector according to the first embodiment of the present invention when the fast charging dual mode charging connector is viewed from another side. FIG. 5A is a sectional view illustrating the fast charging dual mode charging connector according to the first embodiment of the present invention. FIG. 5B is a sectional view of the fast charging dual mode charging connector in which a second surface of a plug is inserted into a USB connection port to be connected to the USB connection port.

As illustrated in FIGS. 1 to 5, the fast charging dual mode charging connector according to the first embodiment of the present invention includes a body 10, a plug 20, and a switch 30.

The body is formed at one end of the USB cable, and an opposite end of the cable is connected to a portable terminal.

The plug 20 is mounted on the body 10, and as illustrated in FIG. 2, one end of the plug 20 may protrude to the front side of the body 10 to be inserted into the USB connection port mounted on a computer or the like.

In the drawing, the front side corresponding to the left side to which the plug 20 protrudes.

A movement groove 11 is formed in the body 10 in the lengthwise direction of the plug 20.

That is, as illustrated in FIG. 4B, the movement groove 11 is formed lengthily on a lower surface of the body 10 forwards and rearwards.

A first stopper step 12 and a second stopper step 13 are formed on opposite sides of the body 10 with respect to the movement groove 11 to be spaced apart from each other forwards and rearwards.

The first stopper step 12 and the second stopper step 13 restrict movement of the switch 30.

As illustrated in FIG. 3, the first stopper step 12 is formed on a lower surface of one end of the body 10 from which the plug 20 protrudes.

A first fixing boss 14 protruding forwards is formed on the rear side of the body 10.

The first fixing boss 14 is a part to which a resilient body 33 of the switch 30 is fixed.

Meanwhile, a case 15 is mounted to the body 10 to surround the body 10 and the plug 20.

As illustrated in FIG. 1, the case 15 may be formed to surround both the body 10 and the plug 20, but may be manufactured to surround only an outer side of the body 10 such that one end of the plug 20 completely protrudes to the outside according to a coupling structure with the USB connection port.

A first data terminal 21a for data communication and a first charging terminal 21b for charging are formed on any one of opposite surfaces of the plug 20, and a second data terminal 22a and a second charging terminal 22b are formed on an opposite surface of the plug 20.

Hereinafter, a surface on which the first data terminal 21a and the second charging terminal 21b are formed is referred to as a first surface, and a surface on which the second data terminal 22a and the second charging terminal 22b is referred to as a second surface.

The second surface of the plug 20 is one surface on which the movement groove 11 of the body 10 is formed, and as illustrated in FIG. 4B, is a lower surface of the plug 20.

As illustrated in FIG. 4B, the plug 20 may be classified into a mounting part 20a mounted to the body 10, and an insertion part 20b protruding from the body 10 to be inserted into the connection part.

The first data terminal 21a, the first charging terminal 21b, and the second charging terminal 22b are formed lengthily over the mounting part 20a and the insertion part 20b, and the second data terminal 22a is formed only in the mounting part 20a.

Accordingly, the second data terminal 22a is formed in the mounting part 20a to be relatively short, and is exposed to the outside of the body 10 through the movement groove 11.

In detail, the first charging terminal 21b and the second charging terminal 22b include a VBUS (VCC) terminal and a GND terminal, respectively, and the first data terminal 21ab and the second data terminal 22a include a D+ terminal and a D− terminal, respectively.

The basic structures of the data terminals and the charging terminals are disclosed in Korean Utility Model Application Publication No. 20-2010-0005580.

The switch 30 is coupled to the body 10 to be moved in the lengthwise direction of the plug 20, and if the plug 20 is inserted into the connection port and the second charging terminal 22b is connected to the connection port, the switch 30 short-circuits the second data terminal 22a as illustrated in FIG. 3.

In detail, the switch 30 includes a slider 31, a short-circuit part 32, and a resilient body 33.

The slider 31 is moved along the movement groove 11, and as illustrated in FIG. 4, a protrusion 311 inserted into the movement groove 11 is formed in the slider 31.

Stoppers 312 protrude from opposite sides of the slider 31.

The stopper 312 is disposed between the first stopper step 12 and the second stopper step 13 formed in the body 10, and movement of the slider 31 is restricted as the stopper 312 contacts the first stopper step 12 or the second stopper step 13.

That is, as illustrated in FIG. 3A, the slider 31 cannot be further moved forwards (in a direction in which the plug 20 protrudes) while the stopper contacts the first stopper step 12, and as illustrated in FIG. 3B, the slider 31 cannot be further moved rearwards while the stopper 312 contacts the second stopper step 13.

The short-circuit part 32 is formed of a metallic material, and protrudes from the rear side of the slider 31.

The short-circuit part 32 is formed to be bent towards the second surface of the plug 20.

As illustrated in FIG. 5, an upper portion of the short-circuit part 32 is bent to have an inverse V-shape an upper portion of which is sharp.

The short-circuit part 32 is moved while contacting the second surface of the plug 20, and if the slider 31 is moved rearwards, the short-circuit part 32 contacts two second data terminals 22a (D+ and D−).

In more detail, the width of the short-circuit part 32 is longer than the distance between the D+ terminal and the D-terminal of the second data terminal 22a such that the D+ terminal and the D− terminal are electrically connected to each other so that the second data terminal 22a is short-circuited.

The resilient body 33 resiliently supports the slider 31 towards one end of the plug 20.

The resilient body 33 is a coil spring, and the second fixing boss 313 is inserted into one end of the resilient body 33 and the first fixing boss 14 is inserted into an opposite end of the resilient body 33 such that the resilient body 33 is disposed between a rear end of the body 10 and the slider 31.

The resilient body 33 may be a spring of various forms that may resiliently support the slider 31, in addition to a coil spring.

The switch 30 has been described in detail according to the embodiment of the present invention, and may include a stress sensor such that the second data terminal 22a is short-circuited by a detection signal of the optical sensor or the stress sensor as the connector is inserted into the USB connection port.

Hereinafter, a method of charging the fast charging dual mode charging connector according to the present invention will be described in detail.

After the connector is separated from the connection port, as illustrated in FIG. 5A, the slider 31 protrudes to the front side of the body 10 that corresponds to one end of the plug 20 by the resilient body 33, and the stopper 312 contacts the first stopper step 12.

The short-circuit part 32 contacts the second surface of the plug 20.

First, if the portable terminal and the USB cable are connected to each other and the connector of the USB cable is connected to the USB port of the computer such that the plug 20 is inserted into the USB connection port so that the first data terminal 21a and the first charging terminal 21b formed on one surface of the plug 20, that is, a first surface of the plug 20 are connected to the USB connection port, data communication is enabled between the computer and the portable terminal and the portable terminal can be charged.

In this way, because the first surface of the plug 20 for both data communication and charging mainly attributes to data communication and secondarily attributes to charging of the portable terminal, a current supplied for charging is limited to a predetermined value for data communication.

Accordingly, in a general USB connector and the present invention, the speed at which the portable terminal is charged through the first surface of the plug 20 is limited.

Meanwhile, when data communication is not necessary between the portable terminal and the computer, if the plug 20 is inserted into the USB connection port such that the second terminal 22b formed on the second surface of the plug 20 is connected to the USB connection port as illustrated in FIG. 5B, the slider 31 compresses the resilient body 33 while being moved rearwards (to the right side of the drawing) by an injection-molded object of the USB connection port having the terminals corresponding to the data terminal and the charging terminal of the plug 20 or a PCB 40.

At the same time, the short-circuit 32 mounted on the slider 31 contacts the D+ terminal and the D− terminal of the second data terminal 22a to short-circuit the second data terminal 22a.

Then, a resistor of a maximum of 200Ω is connected to the second data terminal 22a.

If the slider 31 is moved rearwards, the stopper 312 contacts the second stopper step 13 to restrict a distance by which the slider 31 may be moved rearwards.

In this way, as the portable terminal recognizes the USB connection port as a dedicated charging port (DCP) if the second data terminal 22a is short-circuited by the short-circuit part 32, a current corresponding to a current limited for data communication or more is supplied to the portable terminal through the second charging terminal 22b to charge the portable terminal at a speed faster than a charging speed through the first charging terminal 21b (or a general USB connector).

Accordingly, the user may select a connection surface of the plug 20 to perform both data communication and charging, or to charge the portable terminal at a high speed without performing data communication.

It is preferable that a separate indication be displayed on a surface of the case 15 such that the user distinguishes the first surface (data communication+charging) from the second surface (fast charging) of the plug 20.

If the portable terminal is completely charged such that the connector is separated from the USB connection port, the slider 31 is moved forwards by the resilient body 33 to protrude from one end of the body 10 and the stopper 312 contacts the first stopper step 12 such that movement of the slider 31 is restricted so that the state of the slider 31 is maintained.

### Second Embodiment

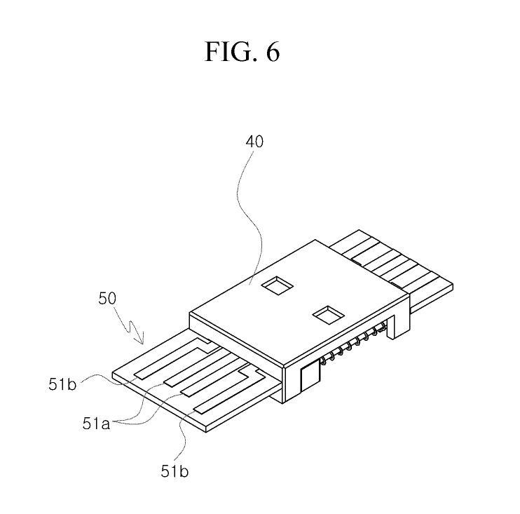

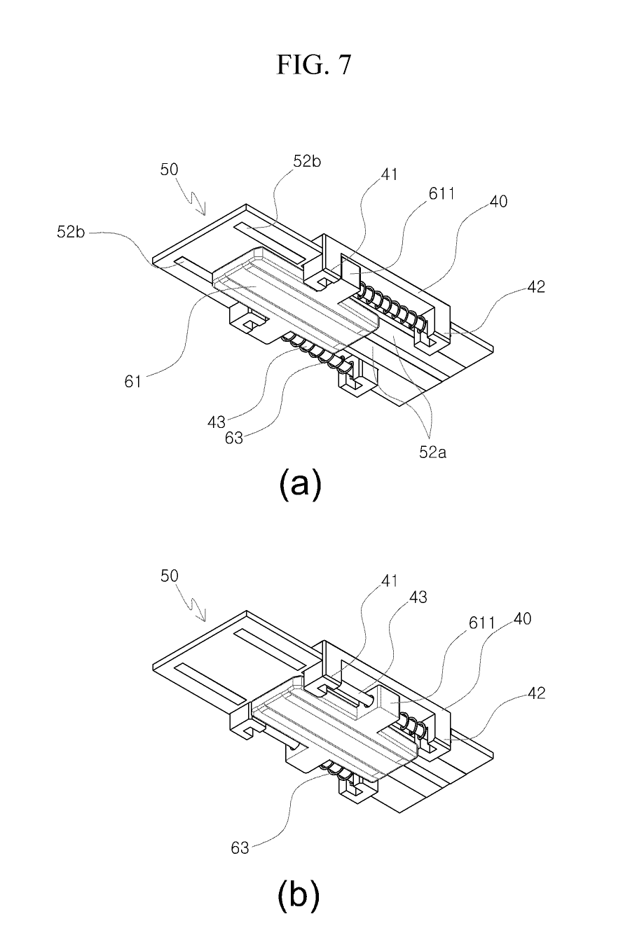

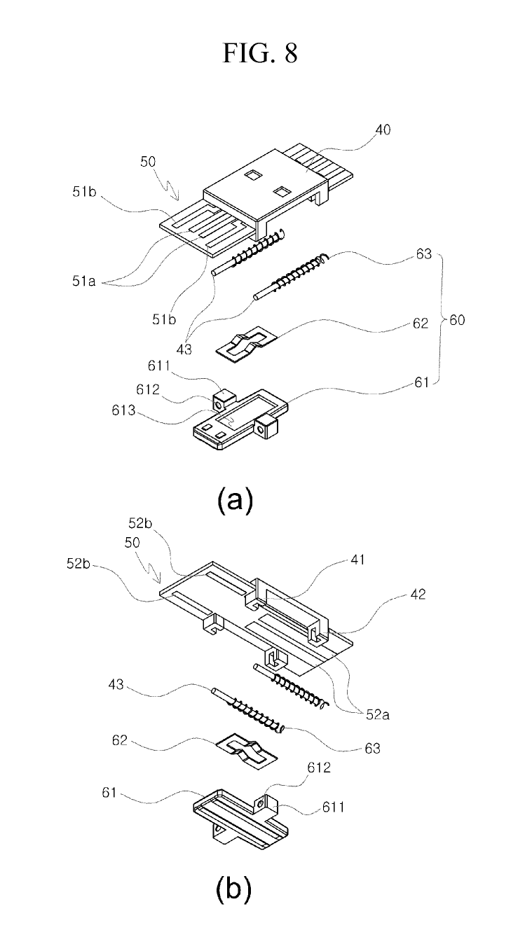

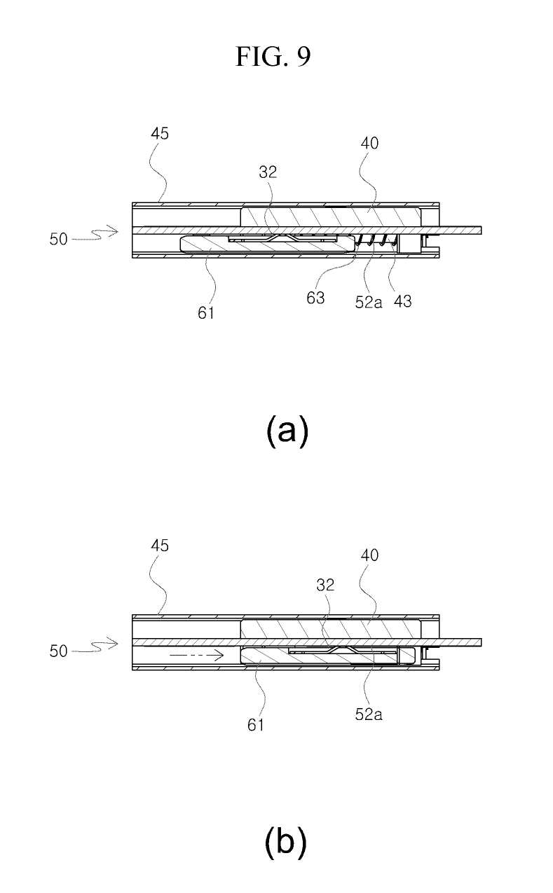

FIG. 6 is a perspective view of the fast charging dual mode charging connector except for a case when the fast charging dual mode charging connector is viewed from one side. FIG. 7A is a perspective view illustrating the fast charging dual mode charging connector according to the second embodiment of the present invention when the fast charging dual mode charging connector is viewed from another side. FIG. 7B is a view illustrating a state in which a slider is moved rearwards from the state of FIG. 7A. FIG. 8A is an exploded perspective view illustrating the fast charging dual mode charging connector according to the second embodiment of the present invention when the fast charging dual mode charging connector is viewed from one side. FIG. 8B is an exploded perspective view illustrating the fast charging dual mode charging connector according to the second embodiment of the present invention when the fast charging dual mode charging connector is viewed from another side. FIG. 9A is a sectional view illustrating the fast charging dual mode charging connector according to the second embodiment of the present invention. FIG. 9B is a sectional view of the fast charging dual mode charging connector in which a second surface of a plug is inserted into a USB connection port to be connected to the USB connection port.

FIG. 9B does not illustrate a USB connection port separately.

The differences between the fast charging dual mode charging connector according to the second embodiment of the present invention and that of the first embodiment of the present invention lie in a body and a switch.

As illustrated in FIGS. 6 to 9, the fast charging dual mode charging connector according to the second embodiment of the present invention includes a body 40, a plug 50, and a switch 60.

As illustrated in FIG. 6, the plug 50 is mounted on the body 40, and as illustrated in FIG. 7, a first fixing part 41 and a second fixing part 42 are formed on opposite sides of the body 40 to be spaced apart from each other forwards and rearwards.

Recesses are formed on facing surfaces of the first fixing part 41 and the second fixing part 42, and a guide pin 43 is inserted into the recesses.

That is, opposite ends of the guide pin 43 are inserted into the recess of the first fixing part 41 and the recess of the second fixing part 42.

The guide pin 43 guides movement of the switch 60.

In detail, as illustrated in FIG. 8, the switch 60 includes a slider 61, a short-circuit part 62, and a resilient body 63.

Stoppers 611 protrude from opposite sides of the slider 61, and guide holes 612 into which the guide pin 43 is inserted is formed in the stoppers 611.

Accordingly, the slider 61 is moved forwards and rearwards along the guide pin 43.

The stopper 611 is disposed between the first fixing part 41 and the second fixing part 42, and contacts the first fixing part 41 to restrict the slider 61 from being moved forwards.

A mounting recess 613 is formed on a surface of the slider 61 facing the plug 50.

The short-circuit part 62 is inserted into the mounting recess 613.

The short-circuit part 62 is formed of a metallic material, and is formed to be bent towards the second surface of the plug 50 as in the first embodiment of the present invention.

As illustrated in FIG. 9, the short-circuit part 62 is moved while contacting the second surface of the plug 20, and if the slider 61 is moved rearwards, it contacts the two second data terminals 52a (D+ and D−) to short-circuit the second data terminal 52a.

The resilient body 63 is a coil spring, and the guide pin is inserted into the resilient body 63 to be disposed between the stopper 611 and the second fixing part 42 such that the resilient body 63 resiliently supports the slider 31 towards one end of the plug 20.

Because the resilient body 63 is compressed and expanded while the guide pin 43 is inserted into the resilient body 63, the resilient body 63 is not deflected in the compression process.

The other items of the second embodiment are the same as those of the first embodiment, and a detailed description thereof will be omitted.

The fast charging dual mode charging connector according to the present invention is not limited to the above-described embodiment, but may be variously deformed without departing from the spirit of the present invention.

1. A fast charging dual mode charging connector comprising:
a plug having a first data terminal for data communication and a first charging terminal for charging on any one of opposite surfaces thereof and having a second data terminal and a second charging terminal on an opposite surface thereof, and having one end inserted into a connection port;
a body on which the plug is mounted such that one end of the plug protrudes; and
a switch for, if the plug is inserted into the connection port such that the second charging terminal is connected to the connection port, short-circuiting the second data terminal.

2. The fast charging dual mode charging connector of claim 1, wherein the body has a movement groove, and the switch comprises:
a slider moved along the movement groove;
a short circuit part mounted on the slider to short-circuit the second data terminal while contacting the second data terminal if the slider is moved towards an opposite end of the plug; and
a resilient body resiliently supporting the slider towards the one end of the plug.

3. The fast charging dual mode charging connector of claim 2, wherein a first stopper step and a second stopper step are formed in the body to be spaced apart from each other in the lengthwise direction of the plug, a stopper disposed between the first stopper step and the second stopper step protrudes from the slider, and movement of the slider is restricted while the stopper contacts the first stopper step or the second stopper step.

4. The fast charging dual mode charging connector of claim 1, further comprising
a guide pin mounted on the body, for guiding movement of the switch.

5. The fast charging dual mode charging connector of claim 4, wherein the switch comprises:
a slider having a guide hole into which the guide pin is inserted such that the guide pin is moved along the guide hole;
a short circuit part mounted on the slider to short-circuit the second data terminal while contacting the second data terminal if the slider is moved towards an opposite end of the plug; and
a resilient body into which the guide pin is inserted and resiliently supporting the slider towards the one end of the plug.

6. The fast charging dual mode charging connector of claim 2, wherein the first charging terminal and the second charging terminal comprise a VBUS terminal and a GND terminal, respectively, the first data terminal and the second data terminal comprise a D+ terminal and a D− terminal, respectively, and the short-circuit part electrically connects the D+ terminal and the D− terminal of the second data terminal.

7. The fast charging dual mode charging connector of claim 2, wherein the plug has a mounting part mounted on the body and an insertion part inserted into the connection port, the first charging terminal, the first data terminal, and the second charging terminal are inserted into the mounting part and the insertion part, and the second data terminal is formed in the mounting part.

8. The fast charging dual mode charging connector of claim 4, wherein the first charging terminal and the second charging terminal comprise a VBUS terminal and a GND terminal, respectively, the first data terminal and the second data terminal comprise a D+ terminal and a D− terminal, respectively, and the short-circuit part electrically connects the D+ terminal and the D− terminal of the second data terminal.

9. The fast charging dual mode charging connector of claim 4, wherein the plug has a mounting part mounted on the body and an insertion part inserted into the connection port, the first charging terminal, the first data terminal, and the second charging terminal are inserted into the mounting part and the insertion part, and the second data terminal is formed in the mounting part.
